(19) United States
(12) Patent Application Publication
(10) Pub. No.: US 2023/0094208 A1
(43) Pub. Date: Mar. 30, 2023

(54) Asset Inventorying System with In-Context Asset Valuation Prioritization

(71) Applicant: Bit Discovery Inc., Santa Clara, CA (US)

(72) Inventor: Robert Stephen Hansen, Austin, TX (US)

(21) Appl. No.: 17/489,668

(22) Filed: Sep. 29, 2021

(51) Int. Cl. G06Q 10/06; G06Q 40/08; G06F 21/57

(52) U.S. Cl. CPC G06Q 10/06375; G06Q 40/08; G06F 21/577; G06Q 10/087

(57) ABSTRACT

A computer-implemented method provides for vulnerability ranking and scoring assets based on remediation action measurements and asset value and risk measurements. A method might comprise obtaining information about a set of assets, obtaining information about environments of assets in the set of assets, determining asset valuation factors for the assets, computing remediation costs for vulnerabilities of the assets, determining returns on investment for remediating the vulnerabilities of the assets, and scoring assets based on remediation action returns on investment.

### FIELD

The present disclosure generally relates to managing assets in a distributed computing environment. The disclosure relates more particularly to apparatus and techniques for prioritizing asset vulnerabilities based on contexts of the assets.

### BACKGROUND

Securing, controlling, and accessing an organization's computer and digital assets having network connectivity is typically on on-going task for network asset managers. As part of those tasks, various vulnerabilities are discovered, need to be discovered, and need to be mitigated. For example, a network asset manager might determine that a class of computers running a particular version of a particular operating system need to be updated to the latest version of the operating system or they will be open to hacking. As another example, the network asset manager might discover that a rogue router has been plugged into their network infrastructure and might in the future be used for unauthorized access to the network. In yet another example, the network asset manager might determine that some servers on their network have a particular vulnerability and mitigating that vulnerability would involve a team of software engineers working over some time period to eliminate that vulnerability.

The solution or response to a discovered vulnerability can vary depending on what the vulnerability is. A rogue router that is not carrying traffic might simply be unplugged from the network and powered off to eliminate the vulnerability caused by the router. The updating of operating systems on a set of computers might be done by setting a configuration manager system to emit triggers to the computers to update themselves and reboot. If a bug has to be tracked down, analyzed, programs written, code tested, etc. to resolve or mitigate a vulnerability, that can be more involved.

Often, in an organization with extensive networked and computer assets, there might be more notices of vulnerability, actually observed vulnerabilities, and bug fixing than there is capacity to immediately address all vulnerabilities. In some organizations, perhaps the easy fixes are prioritized, such as sending someone to unplug a router than having them work on code analysis, or priority is given to whatever vulnerability is most talked about in the day's news. In some cases, prioritization might be based on which management office complains the most. It might be desirable to have a more objective determination of how to prioritize vulnerabilities and remediations.

### SUMMARY

A computer-implemented method provides for vulnerability ranking and scoring assets based on remediation action measurements and asset value and risk measurements. A method might comprise one or more of, alone or in combination, obtaining information about a set of assets, obtaining information about environments of assets in the set of assets, determining asset valuation factors for the assets, computing remediation costs for vulnerabilities of the assets, determining returns on investment for remediating the vulnerabilities, and scoring assets based on remediation action returns on investment.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of methods and apparatus, as defined in the claims, is provided in the following written description of various embodiments of the disclosure and illustrated in the accompanying drawings.

### BRIEF DESCRIPTION OF THE DRAWINGS

Various embodiments in accordance with the present disclosure will be described with reference to the drawings, in which:

FIG. 1 is a block diagram of a system for collecting information on distributed network assets, according to various embodiments.

FIG. 2 is a block diagram of an asset evaluation system usable for measuring and estimating values related to distributed network assets, according to various embodiments.

FIG. 3 shows an example of contents of an asset record as might be found in an asset inventory database, according to various embodiments.

FIG. 4 is a flowchart of a process for determining whether to process an asset record, according to various embodiments.

FIG. 5 shows an example of a value indicator query table, according to various embodiments.

FIG. 6 shows an example of a weighting factors table, according to various embodiments.

FIG. 7 shows a continuation of the weighting factors table of FIG. 6, according to various embodiments.

FIG. 8 is a block diagram of a prioritization system that processes asset data to determine priorities for remediation, according to various embodiments.

FIG. 9 is a block diagram illustrating an example computer system upon which systems illustrated in herein may be implemented, according to various embodiments.

FIG. 10 illustrates an example computer system memory structure as might be used in performing methods described herein, according to various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

As explained herein, an asset scanning system, or other system for collecting information about the network-accessible assets, might collect information about assets of interest and their particular elements and environment, the assets might be in the form of hardware, software, firmware, etc. and might be assets owned, associated, and/or controlled by an entity directing or requesting the collection of information about the assets. As an example, a large company might be interested in inventorying the various computers, routers, servers, and other equipment that is connected to networks and other resources owned, controlled, or maintained by the company as part of a network audit, a security review, or other analysis. The information obtained by the asset scanning system, or that might be provided by some other source, can be used to evaluate the various assets to determine a prioritization to remediate vulnerabilities with respect to those assets. In part, a prioritization might be a function of a set of determined, estimated, provided, and/or calculated values related to a value of an asset to its operator, a value of a cost of replacement of the asset, a value of a vulnerability risk, and/or other values.

As used herein, an asset is some tangible resource that might have value to the asset's operator, which value could be diminished by intrusions, hacking, and/or unauthorized modification or accessing of the asset. An asset might comprise Internet connected or internal network connected devices. Examples of assets might include web servers, name servers, IoT devices, network printers, etc.

An asset might have an associated cost, and in some cases that associated cost can exceed the value. For example, there might be a server that an operator maintains and pays for ongoing network connectivity, but that server is never accessed by anyone or any machine. In that case, the server might have zero value, but has an ongoing expense. A prioritization of that server might give a high priority not to fixing a vulnerability of that asset, but a high priority for scheduling the server to be taken offline and decommissioned. In such cases, removing or decommissioning an asset or a portion of an asset might be considered remediation if it reduces a risk of a vulnerability being exploited and/or reduces an extent to which the vulnerability can be exploited.

In some applications, remediation of a vulnerability might comprise taking an action to reprogram a vulnerable asset to eliminate the vulnerability, reduce the risk of the vulnerability being exploited, and/or mitigating effects of exploitation f the vulnerability. Remediation might occur before the vulnerability is exploited or damage to a value of a vulnerable asset occurs, and/or remediation might occur after the vulnerability is exploited and/or damage to the value of the asset occurs and in the latter case remediation might include processing to restore, or partially restore a value of the asset. For example, reduction of risk of a vulnerability might be done by patching program code or removing an unused but vulnerable asset from a network that needs to be secure.

In some implementations, an asset is representable in computer-readable memory by a tuple of a hostname, a record type, and an IP address. When applicable, a record value might be included. For instance, a CNAME record may point to another CNAME record and so on, and where it points and the IP address to which it finally resolves could be an identifier of an asset. For example, a first asset might be represented by a tuple (www.example.com, A, 192.0.2.111), a second asset by a second tuple (www.example.net, CNAME, www.example.org, 192.0.2.222), and a third asset by a third tuple (www.example.net, CNAME, www.example.org, 192.0.2.333). Using this representation, an asset scanning system might discover multiple assets associated with a single hostname, to evaluate each of those assets, inventory them, and/or test them. This might be used to find applications that are incorrectly configured within a cluster, or find geographically diverse assets.

As used herein, an asset might be a hardware or software system that can have a value and can have vulnerabilities. In some cases, the hardware or software system is what is open to vulnerabilities. In other cases, it might be a pathway, control, or interface that has vulnerabilities. For example, a domain name might point to particular hardware connected to a network and it might have its own vulnerabilities. There might also be a vulnerability if paths that others us to access that hardware is compromised. Thus, in one aspect, control over paths and domain names can be treated as assets, if they have value and can have vulnerabilities.

As used herein, an operator of an asset could be a legal owner of the asset, an entity tasked with maintaining the asset on behalf of others or themselves, an entity that controls the asset, and/or an entity having an interest in maintaining security of the asset. Maintaining an asset might comprise identifying whether vulnerabilities exist that might allow for unauthorized modification or accessing of the asset, whether vulnerabilities exist that might prevent authorized use of the asset, what value of the asset might change if unauthorized modification or access occurs or if authorized use is made unavailable, identifying possible remediation activities, determining costs of the remediation activities, and/or determination of probabilities of occurrence of events related thereto.

Using the system, an operator can identify relative value of an asset and risk quantification. In one example, the risk to an asset would be the probability of damage times a damage potential where the damage potential is a percent of the asset value. The outputs of the system can be used for a network security team to allocate resources and determine which vulnerabilities are worth fixing. Valuation of an asset can be automated based on factors determinable by an asset scanning system and/or an asset evaluation system such as page count, page views, what types of technology is running on it, etc. This information can be used to determine CAPEX, OPEX, and revenue.

In another example, a risk calculation is to determine a cost of exploitation post-compromise. That cost might be a percentage of the asset's value or a numerical value decline amount (wherein the decline might be due to some event), times a probability of the event occurring, plus a cost of pre-compromise remediation. The cost of pre-compromise remediation might be an estimate of a cost (which can be measured as a numerical value or a percentage of asset value) to remediate a vulnerability that could compromise the asset. Then, the ROI could be computed as a cost of a post-compromise exploitation divided by a cost of pre-compromise remediation or the post-compromise cost of exploitation, all reduced by the cost of pre-compromise remediation. In some embodiments, both calculations can be performed and priority computed based on the larger of the quantities. This can be used to not only determine what assets are worth fixing, but in what order they should get fixed. By automating parts of this process and using available data, better prioritizations schedules for remediations can be generated, at least compared to someone having generalized notions of which vulnerabilities should be fixed before others.

In some embodiments, the system can be used to identify relative values of actions that might not be considered risk mitigation and the teachings here that use vulnerability remediation might also be applied to other actions. For example, if the system discovers that some asset is nonoperational, the system can determine the cost of leaving the system alone (such as the ongoing hosting costs, electricity costs, costs of SSL/TLS certification, etc.) versus taking an action to repair the asset or take it offline.

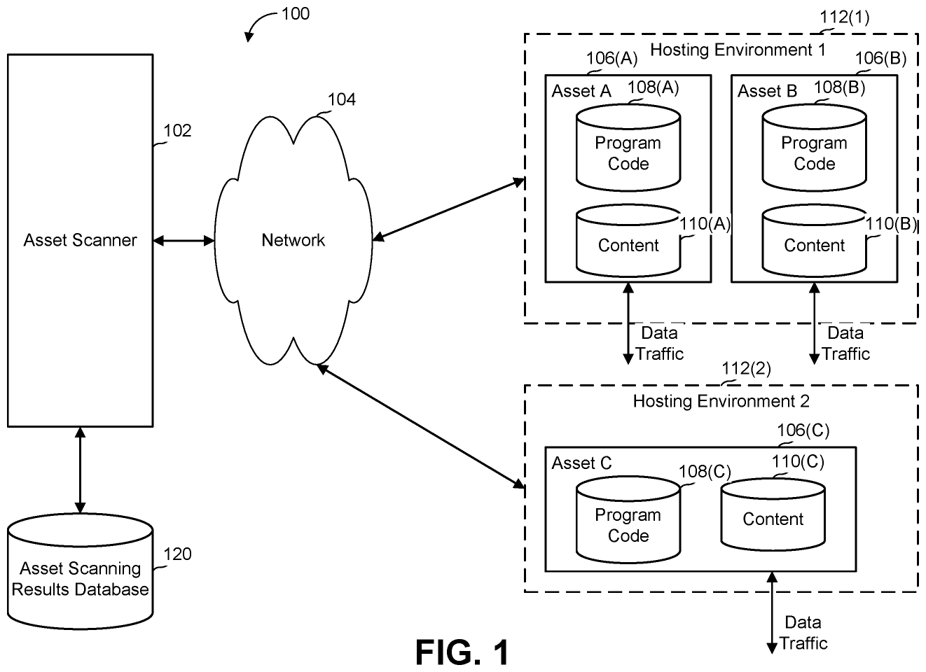

FIG. 1 is a block diagram of a system 100 for collecting information on distributed network assets, according to various embodiments. As illustrated there, an asset scanning system 102 communicates over a network 104, such as the Internet, an intranet, or other network, to connected with various assets, such as asset 106(A), asset 106(B), and/or asset 106(C). An asset might be a server, an Internet-connected device, a data storage system, or other computer or electronic device that might have exploitable vulnerabilities. As shown, each asset 106 comprises program code (108(A), 108(B), 108(C)) and content (110(A), 110(B), 110(C)) and assets 106 operate in hosting environments 112, such as hosting environment 112(1) and hosting environment 112(2). Data traffic to and from assets might also be present. A hosting environment might be a physical environment, such as a shopping website that is an asset hosted on a secure server, but a hosting environment might be a logical environment, such as where a particular router is deemed to be part of a hosting environment associated with Company ABCD Co. because the router's network address is one known to be associated with Company ABCD Co.

As asset scanning system 102 collects information about assets and uses that information to identify other assets possibly operated by a common operator, asset scanning system 102 might store information about assets discovered while scanning into an asset scanning results database 120. An operator, possibly after having acquired other entities, there might not be a central record of what assets that owner owns. Asset scanning can discover those assets.

Asset scanning might involve processing a list of hostnames, identifying corresponding IP addresses, attempting to access ports at those IP addresses, etc. to identify and inventory assets. Asset scanning might involve spidering to find additional assets that might be linked into some way to assets directly associated with hostnames on the list of hostnames. Assets could be identified in other ways besides connecting to a homepage of a domain on the list of hostnames and following links.

An example of an asset is a domain. There are many Internet-connected assets that can be identified by a URL that refers to a domain and typically assets identified by a domain are under common ownership or control. Internet-connected or Internet related assets might include designators such as domains (identifiable by domain names), subdomains (e.g., a domain name with a hostname appended, sometimes more accurately described as a fully qualified domain name, or FQDN), IP addresses, virtual hosts, and/or any combination thereof, and devices connected to the Internet or an internal network that use those designators might also be assets of the owner of those designator assets. Internet-connected assets might be on public networks, non-routable or internal networks, etc.

Assets may include web servers, name servers, IoT devices, desktop computers, network printers, mail servers, other servers, hosts, etc. An asset inventory might be represented by a data structure, such as a relational database, that indicates the assets and metadata of each asset. Metadata about the assets in an asset inventory might include hostnames, details of vulnerabilities, open ports used, etc. Other metadata might include geolocation, operating system, service banners, TLS certificate details, etc. that inform asset evaluator systems about an asset's environment.

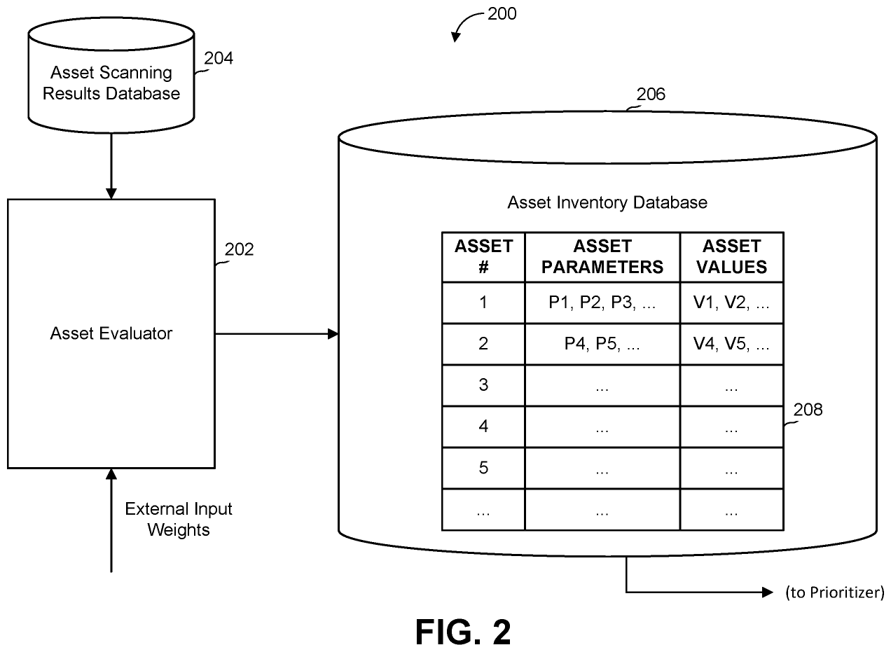

FIG. 2 is a block diagram of an asset evaluation system 200 usable for measuring and estimating values related to distributed network assets, according to various embodiments. As illustrated there and asset evaluator 202 and read data from an asset scanning results database 204, which might be the same or similar to asset scanning results database 120 referred to in FIG. 1.

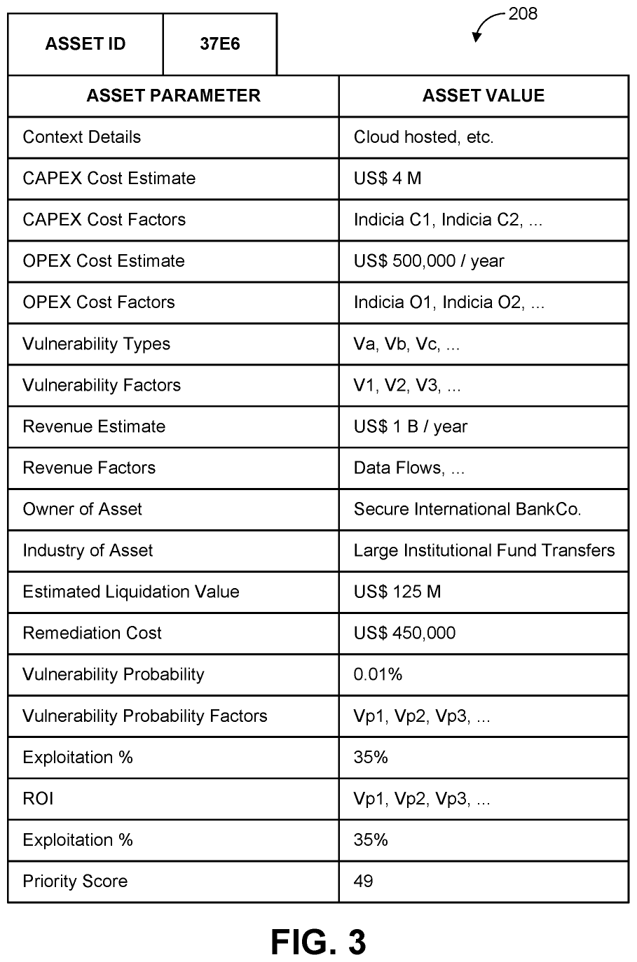

As explained elsewhere herein, asset evaluator 202 evaluates assets and populates an asset inventory database 206 that might contain asset records about a large number of assets an example asset record 208 is described in greater detail with reference to FIG. 3. Once assets are evaluated in asset inventory database 206, results of the evaluation can be output to a prioritizer for generating a priority list that might be used for prioritizing vulnerability fixes needed to secure, or further secure the inventoried assets, remove them from service, sell or otherwise dispose of them, adding or changing insurance on them, or other actions.

In some embodiments, asset inventory database 206 might have asset records that are grouped together in some way. For example, an asset identifier might identify an asset by hostname where that hostname dynamically resolves to one of a plurality of assets. In another example, several hostnames might resolve to the same IP address and refer to the same asset. Data can be stored in asset inventory database 206 to account for these cases. That data might be useful, for example, to allocate value and/or infrastructure cost over more than one asset or to identify when multiple asset records refer to one asset.

FIG. 3 shows an example of contents of example asset record 208 as might be found in an asset inventory database, according to various embodiments. As illustrated there, an asset record might include a unique asset identifier, such as a unique hexadecimal number and further include asset values for a number of asset parameters. In some implementations, the asset parameter labels (the left column of FIG. 3) might be implied by the structure of the asset record and not actually stored as part of the asset record. The asset values might be stored in a compressed form rather than as shown in FIG. 3. Other data might be collected as well or instead.

The asset values might be usable for assessing a valuation of an asset. For instance, a context of an asset might be relevant, such as whether the asset is locally hosted, cloud hosted, etc. Another component of valuation might be based on the presence of various features or settings or details. For example, if an asset is a web presence (such as web pages served by a web server that are collectively considered to be a web site) and includes a login function, that might have a different valuation than the same web presence with no login controls. Some sunk capital expenses (CAPEX) might be estimated for the asset, possibly based on various CAPEX indicia that are discovered during inventorying. As an example, a scan of a web presence might compute an estimate of the number of person-hours it might have taken to create that web presence and use that estimate as part of a CAPEX measurement for that asset. Often, a website that includes a large amount of content can have more value (and have resulted from more CAPEX) than a website comprising only a few simple pages. When prioritizing fixes, if not all fixes can be done immediately, protecting the more valued website might take priority over protecting the lower valued website.

Attributes such as whether an asset is hosted on a cloud-based platform can be used in determining value, as often there is an ongoing operational cost (OPEX) associated with keeping the asset running and the fact that an entity is willing to incur that expense can be another indicator of valuation of the asset. Another indicator could relate to an amount of revenue the asset makes. Revenue might be estimated for an e-commerce website by identifying an approximate value of individual items in a shopping cart, determining a currency, converting to a common currency, and then multiplying by a percentage likelihood of conversions given an estimated traffic flow to the website.

In some embodiments, the stored values labeled as estimates might be actual valuations, as those might be determined by some function of parameters stored or known about the asset. The actual valuations might be derived from accounting or other systems. A remediation cost or an exploitation probability might be known or estimated for individual vulnerabilities, but can be computed or estimated in an aggregate, with prioritization applied to individual vulnerabilities and/or aggregate vulnerabilities. For example, one or more assets that share some vulnerable infrastructure, such as assets sharing a hostname in a round robin load balancer, might have an aggregate vulnerability.

Other aspects of the hosting environment that might affect valuation could include context of an asset such as by doing a bag-of-word comparison by industry of the content maintained by the asset, an industry associated with the owner/operator of the asset, etc. For example, a ten-kilobyte data array accessible via an API that is set up by a banking consortium for setting up and pricing large monetary transactions and a ten-kilobyte collection of amateur poetry might both take up the same storage and might exist on similar assets (i.e., a web server connected to the Internet), but breaches of those web servers might result in widely different valuations of the assets and widely different swings in valuation of the asset should a breach that modifies the data occur. Liquidation valuation might be taken into account should total loss of control of an asset occur.

In some embodiments, valuations, risk values, and metadata for an asset can be inherited from another asset when a pivoting risk is detected. A pivoting risk can occur where one asset has a vulnerability that, if exploited, could lead a hacker to an opening on another asset. If one or a plurality of assets are detected and they have associated metadata that indicates that they might be identical assets, or similar or related assets, they might be flagged with a nonzero pivoting risk, which can be used to adjust their overall risk profile better than if the assets were only considered alone. One asset might be in a position to be in danger if one or more of the other assets in a cohort is compromised. By including the inherited risk associated with other assets in the cohort, a vulnerability can be more appropriately ranked in terms of real-actual risk due to pivoting from one compromised asset to another. For example, a development web server that is not used for revenue generation might be considered less valuable than a production web server, but if they both happen to share passwords, network infrastructure, private keys to APIs, and so on, as is often the case, the valuation or risk rating assigned to the development web server might be increased to account for it being a potential conduit to a more valuable asset.

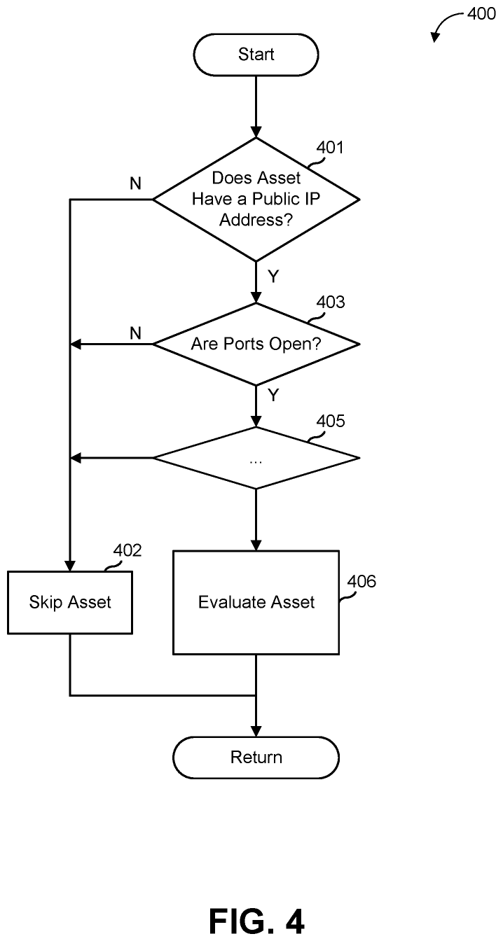

FIG. 4 is a flowchart of a process 400 for determining whether to process an asset record, according to various embodiments. The process might be executed by an asset evaluator. As illustrated there, at step 401, the asset evaluator determines whether the asset has a public IP address. If the asset does not, the asset evaluator moves to step 402, skipping the asset and returning, or moving to the next asset to repeat process 400.

If, at step 401, the asset evaluator determines that the asset has a public IP address, the asset evaluator continues to step 403 and determines whether the asset has any open ports. In some embodiments, the asset evaluator might check whether there are open ports and process assets with open ports differently than assets without open ports. If there are no open ports, it might be that no useful information about the asset could be obtained in a scan. Likewise, if there are no response codes and/or scanning of the asset is not allowed or is disfavored, the asset can be skipped. The asset evaluator could continue with other tests, at step 405 for example, and ultimately decide to evaluate the asset at step 406, and then return or continue with the next asset.

With process 400 described in FIG. 4, an asset evaluator could scan and discover assets and enough metadata to determine a valuation estimate, a risk of loss estimate, a loss percentage or amount, and from that determine a possible downside of doing nothing to fix vulnerabilities. This can be done without privileged access to the assets, such as a proprietary login credential. In some instances, asset scanning might be done without requiring consent of the asset owners, and done from public interfaces of those assets. In other cases, proprietary access to the assets might be provided to contribute additional data and metadata.

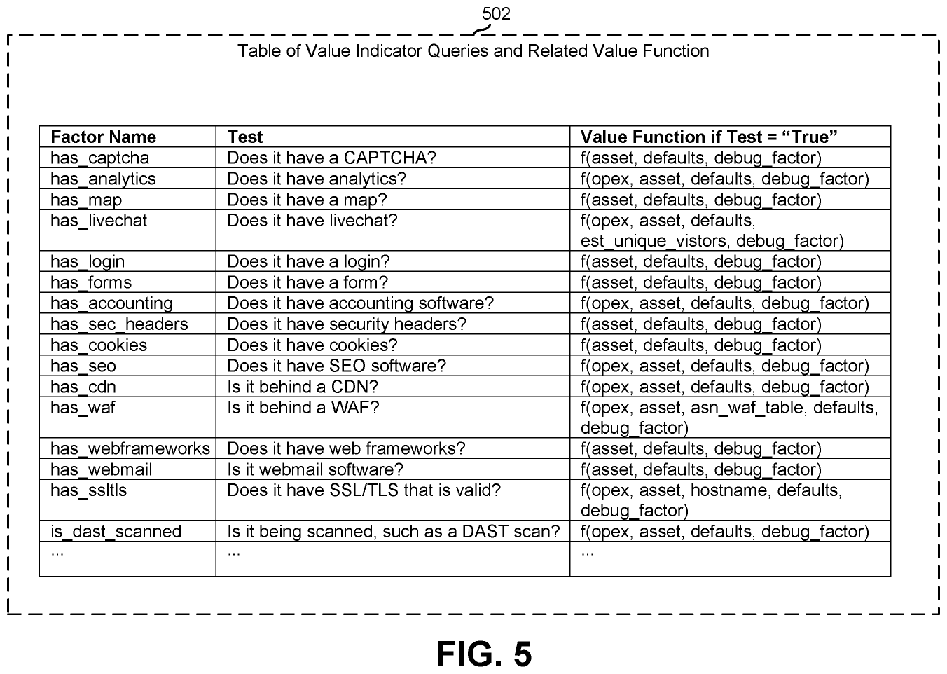

FIG. 5 shows an example of a value indicator query table 502, according to various embodiments. As illustrated there, tests that an asset evaluator might run, and value functions usable to determine a valuation or valuation change are stored in the table. As an example, an asset evaluator could test whether an Internet-accessible asset challenges clients that access the asset to determine if the client is automated or is operated by a human. If such challenges are in place, that can indicate a higher valuation than, all things being equal, no challenges being present.

Other indicia that might affect valuation of an asset might include whether it uses analytics, has a map, provides for a livechat feature, requires a login, includes forms, has accounting software, provides for security headers, sets cookies, performs search engine optimization (SEO), a behind a content distribution network, etc.

Some indicia might relate to OPEX costs, such as whether a CDN is used, a WAF is used, analytics are used, livechat is supported, and other costs can be inferred. The OPEX values could be used to infer a valuation, assuming that an entity expending resources to maintain an asset find a value in that asset. Other indicia might be used to infer a lowered valuation. For example, where a hosting environment of an asset indicates that it is an asset used for administrative purposes, testing, and/or staging, such assets might have lower value when considering valuation losses that might be caused by vulnerabilities. For example, if the same vulnerability exists in a test server and a production server and both cannot be immediately patched, patching the production server might have priority over patching the test server.

In some hosting environment detections, assets that are blocked by others (such as by being on a blocked sites list) likely have lower revenue potential and lowered valuations. An asset might by a domain name and where an HTTP requests of the domain name returns a domain squatting page, the asset's value might be limited to the value of the domain name alone. Where a site redirects off its host to anything other than an authentication page (which redirects back) it likely has little value.

Although tests are illustrated in FIG. 5 in the form of binary questions, the tests could return nonbinary responses in some embodiments rather than being limited to “true” and “false.” In some embodiments, valuation is modified on the fly.

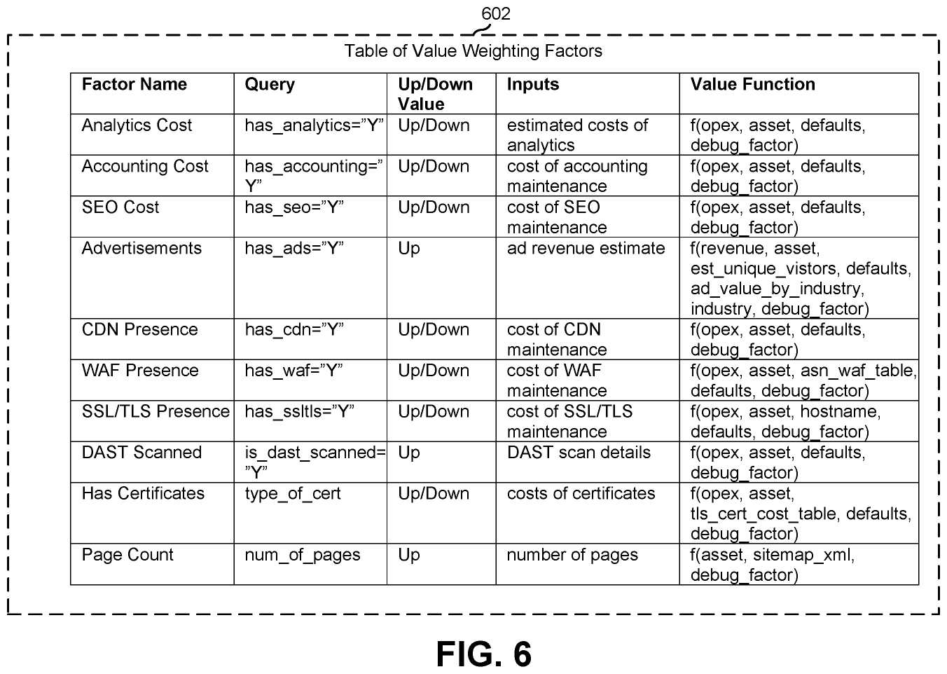

FIG. 6 shows an example of a weighting factors table 602, according to various embodiments. The weighting factors might be determined based on data obtained in scanning. Some weighting factors might be used to increase a valuation of an asset based on indicia that the asset is being protected and maintained. Some weighting factors might be used to decrease valuation of an asset based on its features or environment.

For example, an asset evaluator can determine an operator of an asset and then determine an industry associated with that operator and as a result, assign a weight based on the industry, perhaps as a valuation multiple assigned to the asset. Other valuation indicia might relate to owed property taxes, how operation of the asset is taxed (such as whether it is considered a service or a product and the jurisdiction is it deemed to be operating in. Where assets are typically insured, estimated insurance costs in industries where assets need insurance can be taken into account, as well as costs to get to compliance for assets of their type.

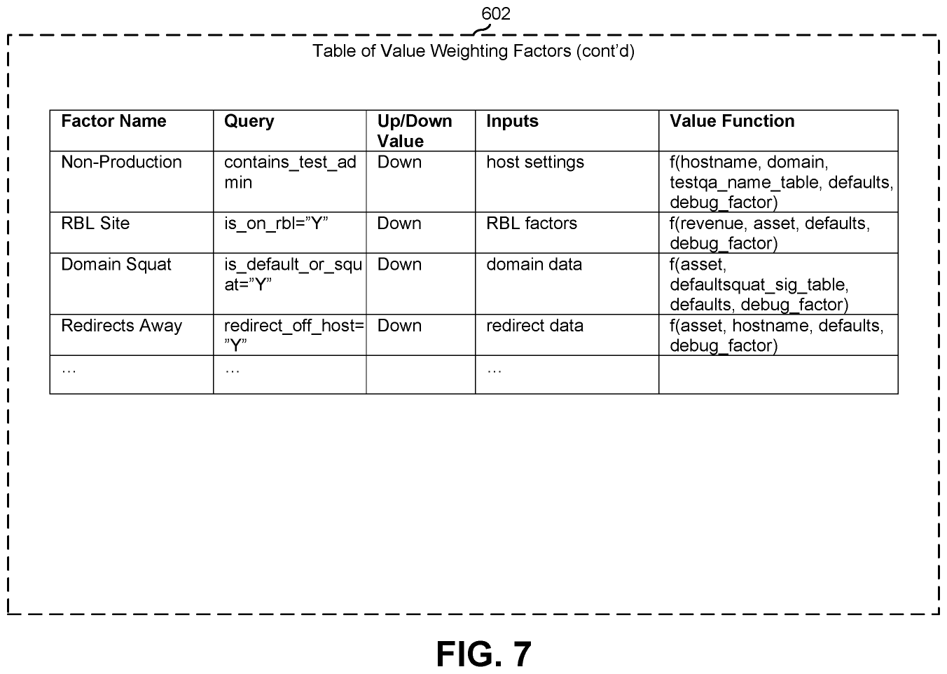

FIG. 7 shows a continuation of the weighting factors table of FIG. 6, according to various embodiments.

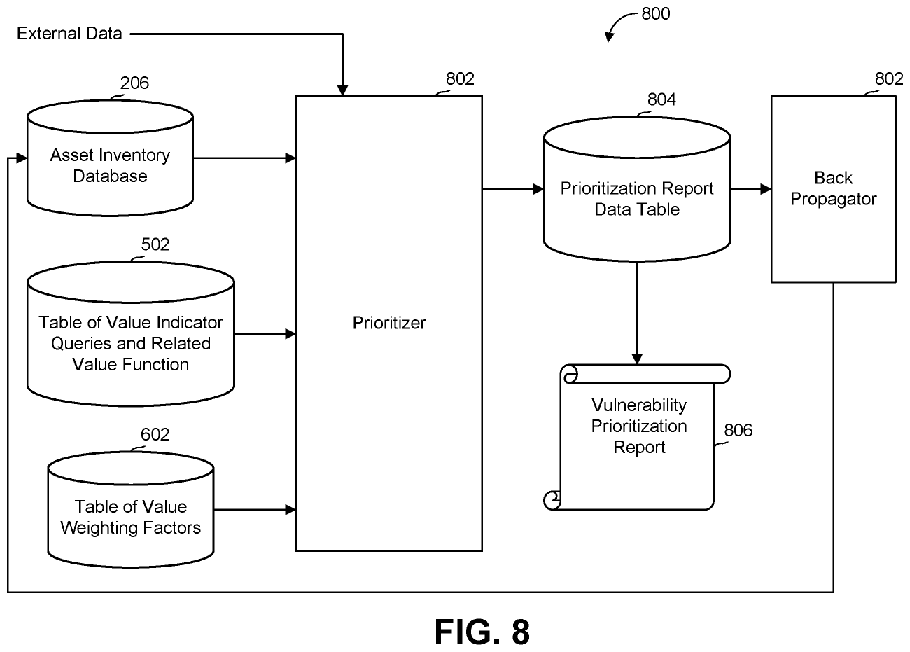

FIG. 8 is a block diagram of a prioritization system 800 that processes asset data to determine priorities for remediation, according to various embodiments. As shown there, a prioritizer 802 receives in data from asset inventory database 206, table of value indicators 502, table weighting factors 602, and possibly also external data and output stated to a prioritization report data table 804. Prioritization report data table 804 can be used for generating a vulnerability prioritization report 806.

Prioritizer 802 might process this data and consider risk factors. For example, suppose prioritizer 802 computes that there is a particular vulnerability on an asset such as a website and an unauthorized party taking advantage of that vulnerability would compromise 50% of the value of that website. Prioritizer 802 can look in the asset's asset record to determine that a value of the asset is $2,000,000, which would have the at-risk dollar figure for the vulnerability be $1,000,000, and also look at the probability of exploitation of the vulnerability to determine the expectation value of loss for the exploit (such as $200,000 when the probability is 0.20). Prioritizer 802 can then look on a remediation cost to determine an estimated return on investment (ROI). For example, if the estimated remediation cost indicated in the asset's asset record is $20,000, the estimated ROI is 10×. In generating a vulnerability prioritization report 806, prioritizer 802 might provide a higher priority score than to an asset with a lower operating value, a lower ROI, or other considerations. In some situations, vulnerabilities with ROIs below some threshold, such as 1.0 or some number higher or lower than that, might be deferred until some of the asset record values change. Vulnerability prioritization report 806 might include assets sorted and ranked/bucketed (such as buckets of (critical|high|medium low|informational)).

Estimated value of an asset might be determined by a size of its content, or its traffic. To figure out how much traffic an asset gets, an asset evaluator might look to interactive speaker data, what kind of shopping carts are provided for, adjusting valuation based on whether an asset has carts, as those might tend to be valued on sales volume, whether the operator is public or private, OPEX of cloud hosted sites, where applicable, and the like.

External inputs can be used to tune the system, which might be used in cases where an asset scanning system is not able to gather all relevant valuation factors and details. Asset gathering and prioritization might be done by an operator of the assets, another user, or perhaps a third-party scanning vendor. External inputs might comprise data provided by others that have different access to the assets being considered.

Prioritizer 802 might include a machine learning engine that processes the available data to revise priority scores. Ordering results of a search by value of assets can be done and the ranking might be used as a ranking factor to be combined with other derivative numeric ranking values. Scoring and ranking might use other inputs besides valuation. For example, if there are risk scores, traffic data, personally identifiable information (PII) present, that might alter a score or ranking without necessarily affecting a valuation. For example, traffic data could be considered in determining an overall score in cases where generalized risk of exploitation increases as traffic to a site increases. As much of the process, or even all of the process, can be performed by systems described herein without requiring human interaction, the scoring and ranking can be kept up-to-date by repeating computations, adjusting values, re-scanning assets, etc.

A back propagator 802 might process some of the data from prioritization report data table 804 to feed back data to asset inventory database 206. This can provide for an ability to determine asset valuations, on a per-asset basis or on groups of assets.

As explained herein, a system can scan for assets, develop an inventory of those assets, and compute a valuation of the assets, without requiring user intervention. In some cases, user input data might be considered. In addition to valuation of an asset, a system can also determine a potential vulnerability of an asset, a loss measure (which can be a loss ratio, a loss amount, or some other function) representing an asset valuation change that might occur if the vulnerability were to be exploited, and a remediation cost of eliminating, mitigating, or otherwise addressing the vulnerability. Remediation costs can be measured on a pre-compromise basis and/or a post-compromise basis, wherein a pre-compromise remediation cost represents a cost of dealing with a vulnerability before it is exploited and a post-compromise remediation cost represents a cost of cleaning up and dealing with the vulnerability after having been exploited. This valuation process can be repeated over a large number of assets. A system, having computed values, loss measures, probability of occurrence of such losses, and remediation costs can then generate data about a set of assets allowing for prioritization of remediation as explained herein. In some embodiments, the data about assets are compared to known attributes of the assets, where those attributes are available, such as CAPEX, OPEX, and/or revenue.

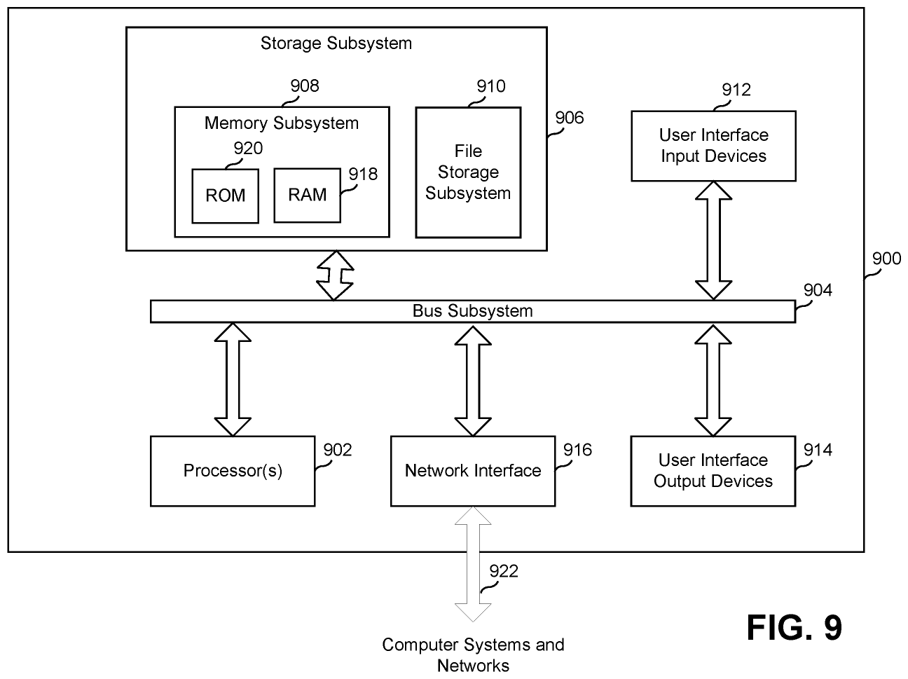

FIG. 9 illustrates details of a system 900 comprising hardware, software, and interfaces that might be used to implement asset scanning system 102, assets, asset evaluator 202, and/or various databases and storage referenced herein. System 900 might comprise one or more computer systems and one or more processors 902 that may be configured to communicate with and are operatively coupled to a number of peripheral subsystems via a bus subsystem 904. These peripheral subsystems may include a storage subsystem 906, comprising a memory subsystem 908 and a file storage subsystem 910, one or more user interface input devices 912, user interface output devices 914, and a network interface subsystem 916.

In some embodiments, the data structures are used by various components and tools, some of which are described in more detail herein. The data structures and program code used to operate on the data structures may be provided and/or carried by a transitory computer readable medium, e.g., a transmission medium such as in the form of a signal transmitted over a network.

Bus subsystem 904 may provide a mechanism for enabling the various components and subsystems of computer system 900 to communicate with each other as intended. Although the bus subsystem 904 is shown schematically as a single bus, alternative embodiments of the bus subsystem may utilize multiple busses.

Network interface subsystem 916 may provide an interface 922 to other computer systems and networks. Network interface subsystem 916 may serve as an interface for receiving data from and transmitting data to other systems such as to obtain asset data, user input, external data collection, user feedback, etc.

The user interface input devices 912 may include a keyboard, pointing devices, and other types of input devices. The user interface output devices 914 may include a display subsystem, a printer, non-visual displays (e.g., audio and/or tactile output devices), or other such display devices. In general, use of the term “output device” is intended to include all possible types of devices and mechanisms for outputting information. The user interface output devices 914 may be used, for example, to generate and/or present user interfaces to facilitate user interaction with applications performing processes described herein and variations therein, when such interaction may be appropriate. In some embodiments, a display can be used to display data received by system 900, and system 900 might include program code for generating such displays, such as a web browser.

The storage subsystem 906 may provide a computer-readable storage medium for storing the programming and data constructs that provide the functionality of the element implemented (such as an asset evaluator, an asset scanner, or a database manager). Software (programs, code modules, instructions) that, when executed by the one or more processors 902 may provide the functionality of the embodiments described herein, may be stored in storage subsystem 906. Storage subsystem 906 may also provide a repository for storing data used in asset evaluation. Example software might include program code to implement the culling, filtering, adjusting, searching, and other functions described herein.

Memory subsystem 908 may include a number of memory devices including, for example, random access memory (RAM) 918 for storage of instructions and data during program execution and read-only memory (ROM) 920 in which fixed instructions may be stored. File storage subsystem 910 may provide a non-transitory persistent (non-volatile) storage for program and data files, and may include a hard disk drive, and other storage media.

System 900 might comprise, or be part of, various types of computers that can be implemented in a wide variety of operating environments, which in some cases can include one or more user computers, computing devices or processing devices that can be used to operate any of a number of applications. User or client devices may include any of a number of general-purpose personal computers, such as desktop, laptop or tablet computers running a standard operating system, as well as cellular, wireless and handheld devices running mobile software and capable of supporting a number of networking and messaging protocols, perhaps depending on user selection of interface. Various embodiments may use at least one network that would be familiar to those skilled in the art for supporting communications using any of a variety of commercially-available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), etc. Storage media and computer-readable media for containing code, or portions of code, can include appropriate media known or used in the art, including storage media and communication media, such as, but not limited to, volatile and non-volatile, removable and non-removable media implemented in any method or technology for storage and/or transmission of information such as computer-readable instructions, data structures, program modules, or other data.

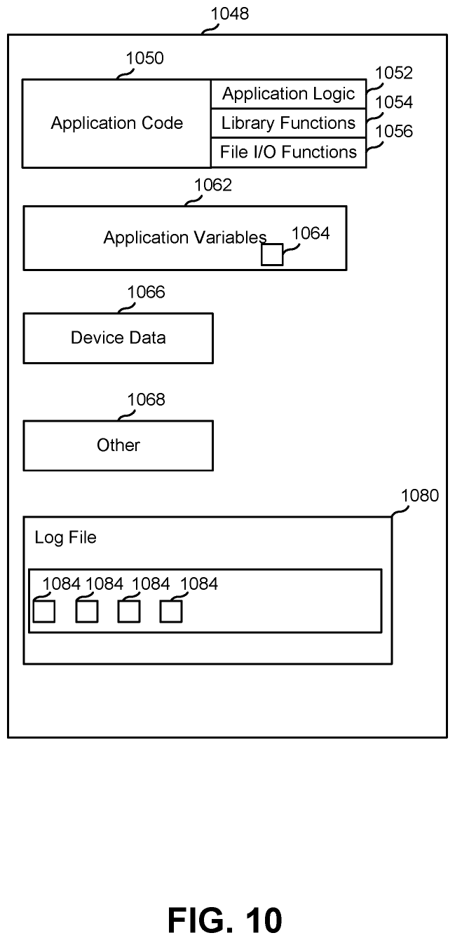

FIG. 10 illustrates elements used as part of an element such as an asset scanner or an asset evaluator, or other computation system described herein, according to an embodiment. FIG. 10 illustrates an example of memory elements that might be used by a processor to implement elements of the embodiments described herein. For example, where a functional block is referenced, it might be implemented as program code stored in memory. FIG. 10 is a simplified functional block diagram of a storage device 1048 having an application that can be accessed and executed by a processor in a computer system as might be part of an element described herein and/or a computer system that manages assets under control or assets being assessed. The application can be one or more of the applications described herein, running on servers, clients or other platforms or devices and might represent memory of one of the clients and/or servers illustrated elsewhere. Storage device 1048 can be one or more memory device that can be accessed by a processor and storage device 1048 can have stored thereon application code 1050 that can be configured to store one or more processor readable instructions. The application code 1050 can include application logic 1052, library functions 1054, and file I/O functions 1056 associated with the application.

Storage device 1048 can also include application variables 1062 that can include one or more storage locations configured to receive application variables 1064. The application variables 1062 can include variables that are generated by the application or otherwise local to the application. The application variables 1062 can be generated, for example, from data retrieved from an external source, such as a user or an external device or application. The processor can execute the application code 1050 to generate the application variables 1062 provided to storage device 1048.

Storage device 1048 can include storage for databases and other data described herein. One or more memory locations can be configured to store device data 1066. Device data 1066 can include data that is sourced by an external source, such as a user or an external device. Device data 1066 can include, for example, records being passed between servers prior to being transmitted or after being received. Other data 1068 might also be supplied.

Storage device 1048 can also include a log file 1080 having one or more storage locations 1084 configured to store results of the application or inputs provided to the application. For example, the log file 1080 can be configured to store a history of actions.

The memory elements of FIG. 10 might be used for a server or computer that interfaces with a user, generates asset data, and/or manages other aspects of a process described herein.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

According to some embodiments, the techniques described herein are implemented by one or more generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

One embodiment might include a carrier medium carrying data that includes data having been processed by the methods described herein. The carrier medium can comprise any medium suitable for carrying the data, including a storage medium, e.g., solid-state memory, an optical disk or a magnetic disk, or a transient medium, e.g., a signal carrying the data such as a signal transmitted over a network, a digital signal, a radio frequency signal, an acoustic signal, an optical signal or an electrical signal.

Storage media is distinct from but may be used in conjunction with transmission media. Transmission media participates in transferring information between storage media. For example, transmission media includes coaxial cables, copper wire, and fiber optics, including the wires that include bus subsystem 904. Transmission media can also take the form of acoustic or light waves, such as those generated during radio-wave and infra-red data communications.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The code may also be provided carried by a transitory computer readable medium e.g., a transmission medium such as in the form of a signal transmitted over a network.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method for vulnerability ranking, comprising:
under control of one or more computer systems configured with executable instructions:
obtaining first information about a set of assets;
obtaining second information about environments of assets in the set of assets;
determining asset valuation factors for the assets, based at least in part on the first information and the second information; and
using the asset valuation factors to determine remediation priority.

2. The computer-implemented method of claim 1, further comprising:
determining a vulnerability list of vulnerabilities of assets; and
determining, for a vulnerability of an asset, a risk factor representing a potential value loss for the asset if the vulnerability were to be exploited.

3. The computer-implemented method of claim 2, further comprising:
computing a remediation cost for the vulnerabilities of the asset;
determining returns on investment for remediating the vulnerability; and
scoring the assets for the remediation priority based on respective remediation action returns on investment.

4. The computer-implemented method of claim 3, wherein the remediation cost represents a cost of addressing the vulnerability prior to the vulnerability being exploited on the asset.

5. The computer-implemented method of claim 3, wherein the remediation cost represents a cost of addressing the vulnerability on the asset.

6. The computer-implemented method of claim 2, wherein the risk factor representing the potential value loss is a ratio representing the potential loss value divided by the cost of remediation.

7. The computer-implemented method of claim 2, wherein the risk factor representing the potential value loss is a value loss amount measured in a unit of currency.

8. A computer-implemented method for vulnerability ranking, comprising:
under control of one or more computer systems configured with executable instructions:
obtaining information about environments of assets in a set of assets;
computing remediation costs for vulnerabilities of the assets; and
scoring assets based on remediation action returns on investment.

9. The computer-implemented method of claim 8, further comprising:
determining asset valuation factors for the assets in the set of assets; and
determining returns on investment for remediating vulnerabilities of the assets.

10. The computer-implemented method of claim 9, wherein the remediation costs are usable in determining the returns on investment.

11. A computer-implemented method for vulnerability ranking and/or remediation ranking substantially as described herein.
